(19) United States
(12) Patent Application Publication
(10) Pub. No.: US 2006/0087786 A1
(43) Pub. Date: Apr. 27, 2006

(54) Negative current generator

(76) Inventor: Bing Yang, Bu Ji Town (CN)

Correspondence Address: LEONG C LEI, PMB # 1008, 1867 YGNACIO VALLEY ROAD, WALNUT CREEK, CA, 94598, US

(21) Appl. No.: 10/972,569

(22) Filed: Oct. 25, 2004

(51) Int. Cl. H02H 3/08

(52) U.S. Cl. 361/93.7

(57) ABSTRACT

A negative current generator employs an adjustment module to change and set the output voltage of the negative current generator, so as to provide an adjustment range for the output voltage.

### BACKGROUND OF THE INVENTION

1. Field of the Invention

This invention generally relates to a negative current generator, and more particularly, to a negative current generator that provides an adjustment range for the output voltage.

2. Description of the Prior Art

In the field of processing foods, a negative current generator is utilized to generate a high voltage in an insulation space to form an electrostatic field, so as to prevent the foods in the insulation space from germs and keep them fresh. Moreover, the negative current generator outputs a micro-current into the foods and makes the foods become charged bodies. Since the micro-current penetrates into the foods, the environmental temperature also enters the inside of the foods by following the micro-current. This status makes the different temperatures between the foods and the environmental temperature quickly balanced, and further, makes the foods be frozen or thawed fast. By doing so, the foods have better abilities to anti-oxidize, prevent moisture from losing, and avoid infecting with germs. Herein, the foods could directly connect to the output of the negative current generator, or could connect to the output of the negative current generator through any conducting objects.

However, a well-known negative current generator does not provide an adjustable output voltage. Thus, the well-known negative current generator cannot reduce its output voltage to meet the practical needs while a load only needs a lower output voltage. In view of the drawbacks mentioned with the prior art of negative current generator, there is a continued need to develop a new and improved negative current generator that overcomes the disadvantages associated with the prior art of negative current generator. The advantages of this invention are that it solves the problems mentioned above.

### SUMMARY OF THE INVENTION

In accordance with the present invention, a negative current generator substantially obviates one or more of the problems resulted from the limitations and disadvantages of the prior art mentioned in the background.

The present invention provides a negative current generator to generate a high voltage to ionize the moisture in objects, so as to make the molecules of the moisture small and tight to isolate the air and prevent germs from reproducing.

The present invention provides a negative current generator to generate a micro-current to penetrate the objects, so as to make the environmental temperature enter the inside of the objects to quickly balance the temperature differences between the objects and the environmental temperature.

The present invention provides an adjustment module to change and set the output voltage of the negative current generator, so as to provide an adjustment range for the output voltage.

In accordance with the present invention, a negative current generator is disclosed. The negative current generator includes a transforming module, a current-limited module, and an adjustment module. The transforming module receives a first voltage, induces, and outputs a second voltage, wherein the transforming module has a first output and a second output. The current-limited module limits the current of the second voltage, wherein the current-limited module electrically couples to the first output of the transforming module. The adjustment module adjusts the second voltage, wherein the adjustment module includes a conducting wire electrically coupling to the second output of the transforming module, the second voltage is a maximum when the conducting wire is grounded; and when the conducting wire is floated, the second voltage is less than the maximum and increases when the conducting wire lengthens.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A illustrates a preferred embodiment structure diagram in accordance with the present invention;

FIG. 1B illustrates one preferred structure diagram of FIG. 1 in accordance with the present invention; and

FIG. 2 illustrates a preferred transforming module structure in accordance with the present invention.

### DESCRIPTION OF THE PREFERRED EMBODIMENT

Some embodiments of the invention will now be described in greater detail. Nevertheless, it should be noted that the present invention can be practiced in a wide range of other embodiments besides those explicitly described, and the scope of the present invention is expressly not limited except as specified in the accompanying claims.

Moreover, some irrelevant details are not drawn in order to make the illustrations concise and to provide a clear description for easily understanding the present invention.

A negative current generator has a transforming module, a current-limited module, and an adjustment module. The transforming module receives a first voltage, induces, and outputs a second voltage, wherein the transforming module has a first output and a second output. The current-limited module limits the current of the second voltage, wherein the current-limited module electrically couples to the first output of the transforming module. The adjustment module adjusts the second voltage, wherein the adjustment module includes a conducting wire electrically coupling to the second output of the transforming module, the second voltage is a maximum when the conducting wire is grounded; and when the conducting wire is floated, the second voltage is less than the maximum and increases when the conducting wire lengthens.

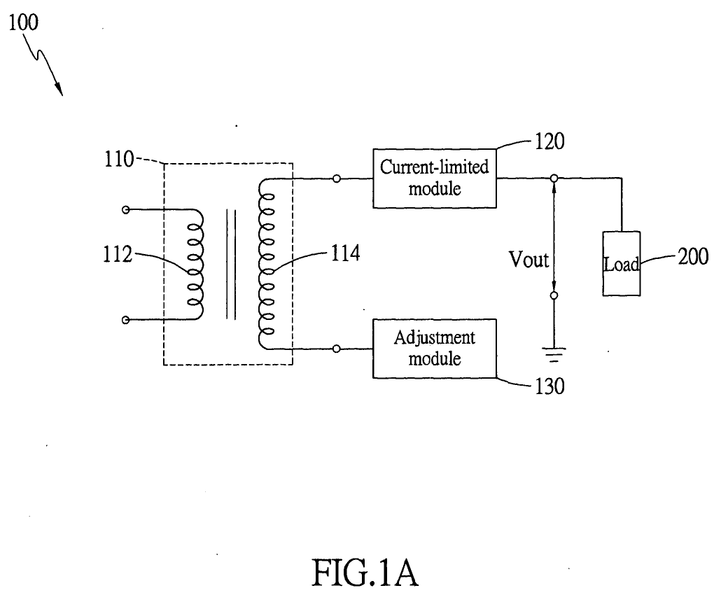

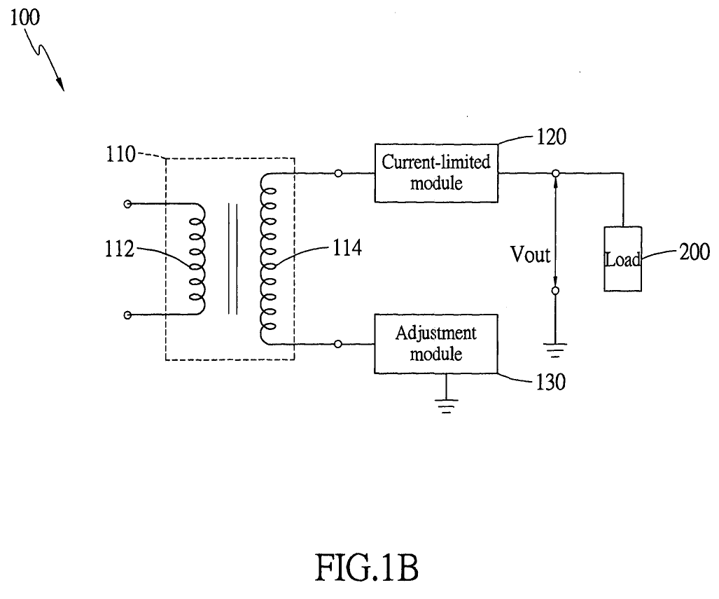

Referring to FIG. 1A, a preferred embodiment structure diagram in accordance with the present invention is illustrated. A negative current generator 100 has a transforming module 110, a current-limited module 120, and an adjustment module 130. The transforming module 110 receives a first voltage (also called an input voltage), induces and outputs a second voltage. Wherein, the transforming module 110 includes a four-terminal component having two inputs and two outputs. In this embodiment, the transforming module 110 is a transformer, but should not be limited to. A first coil 112 and a second coil 114 of the transformer are respectively formed by a B-class polyester enameled copper wire (PEW) with a 0.5-0.6 millimeter diameter and a B-class polyester enameled copper wire with a 0.05-0.06 millimeter diameter. The current-limited module 120 electrically couples to one output of the transforming module 110 to limit the current of the second voltage induced by the transforming module 110 and output an output voltage Vₒᵤₜ. Wherein, the current-limited module 120 includes at least one resistor. In this embodiment, the current-limited module 120 is a series connection formed by two resistors, but should not be limited to. The adjustment module 130 electrically couples to the other output of the transformer 110 to adjust the second voltage induced and outputted by the transforming module 110 and the output voltage Vₒᵤₜ outputted via the current-limited module 120. In this embodiment, the adjustment module 130 is a conducting wire, but should not be limited to. When the conducting wire is floated, the second voltage increases while the conducting wire lengthens, so as to provide different voltage to meet the practical needs. A load 200 could be the foods or the objects mentioned above. They could directly connect to the output of the current-limited module 120, or could connect to the output of the current-limited module 120 through any conducting objects.

Referring to FIG. 1B, one preferred structure diagram in FIG. 1 is illustrated. The main different between FIG. 1B and FIG. 1A is that the adjustment module 130 is grounded or not. When the adjustment module 130 is grounded, the second voltage is a maximum. That is, under the same conditions, the second voltage in the adjustment module 130 being grounded is bigger than the second voltage in the adjustment 130 being floated. For example, when the conducting wire is grounded, the second voltage is about 8300 voltages no matter how long the conducting wire is. But, when the conducting wire is floated, the second voltage is about 2800 voltages while the conducting wire is stretched and its length is 1 meter; the second voltage is about 3100 voltages while the conducting wire is stretched and its length is 1.5 meters; and the second voltage is about 2400 voltages while the length of the conducting wire is 1.5 meters but is rolled. For another example, when the conducting wire is grounded, the second voltage is about 2600 voltages no matter how long the conducting wire is. But, when the conducting wire is floated, the second voltage is about 1280 voltages while the conducting wire is stretched and its length is 0.5 meter; the second voltage is about 1350 voltages while the conducting wire is stretched and its length is 1 meter; the second voltage is about 1460 voltages while the conducting wire is stretched and its length is 2 meters; and the second voltage is about 1200 voltages while the length of the conducting wire is 2 meters but is rolled. The data mentioned above is used for the explanation, and should not be used to limit the present invention.

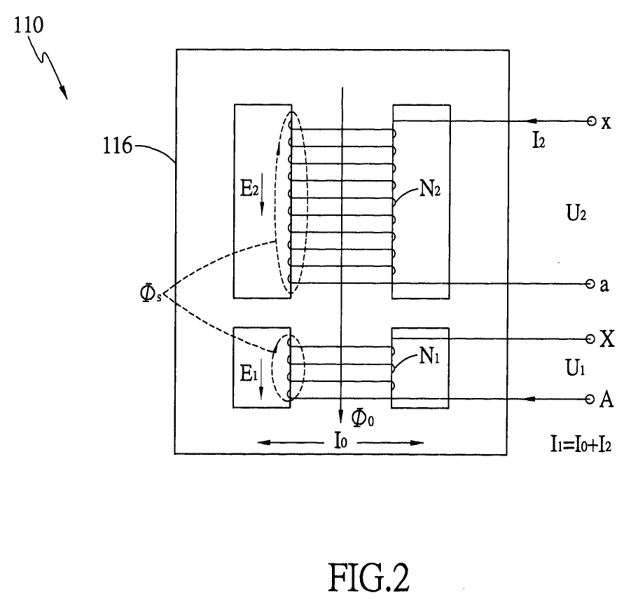

Referring to FIG. 2, a preferred transforming module structure in accordance with the present invention is illustrated. A first coil N₁ generates an exciting current I₀ when the terminal A, X of the first coil N₁ is applied to a first alternating voltage U₁. A main magnetic flux Φ₀ on a set of silicon steel 116 and a leakage flux Φₛ on the outside loop of the set of silicon steel 116 are also generated. The main magnetic flux Φ₀ respectively generates a first induced voltage E₁ on the first coil N₁ and a second induced voltage E₂ on a second coil N₂, and thus, a second voltage U₂ is generated on the terminals a, x of the second coil N₂. When the second coil N₂ connects a load, a second current I₂ is thus generated and the no-load current of the first coil N₁ increases from the exciting current I₀ to a first current I₁, where I₁=I₀+I₂. If the exciting current is ignored, U₂/U₁=E₁/E₂=N₁/N₂=I₂/I₁. Wherein, the first coil N₁ and the second coil N₂ are respectively formed by a B-class polyester enameled copper wire with a 0.5-0.6 millimeter diameter and a B-class polyester enameled copper wire with a 0.05-0.06 millimeter diameter, and the set of silicon steel 116 includes an E shape, an I shape, and a square shape silicon steel.

Although specific embodiments have been illustrated and described, it will be obvious to those skilled in the art that various modifications may be made without departing from what is intended to be limited solely by the appended claims.

What is claimed is:

1. A negative current generator, comprising:
a transforming module, receiving a first voltage, inducing and outputting a second voltage, wherein said transforming module has a first output and a second output;
a current-limited module, limiting the current of said second voltage, wherein said current-limited module electrically couples to said first output of said transforming module; and
an adjustment module, adjusting said second voltage, wherein said adjustment module electrically couples to said second output of said transforming module.

2. The negative current generator according to claim 1, wherein said current-limited module comprises at least a resistor.

3. The negative current generator according to claim 1, wherein said adjustment module comprises a conducting wire.

4. The negative current generator according to claim 3, when said conducting wire grounds, said second voltage is a maximum.

5. The negative current generator according to claim 3, when said conducting wire floats, said second voltage is less than said maximum and said second voltage- increases while said conducting wire lengthens.

6. The negative current generator according to claim 5, wherein said maximum is 8300 voltages, said second voltage is 2400-3100 voltages.

7. The negative current generator according to claim 5, wherein said maximum is 2600 voltages, said second voltage is 1200-1460 voltages.

8. The negative current generator according to claim 1, wherein said transforming module further comprises a first coil and a second coil.

9. The negative current generator according to claim 8, wherein said first coil is made by a B-class polyester enameled copper wire (PEW) with a 0.5-0.6 millimeter diameter.

10. The negative current generator according to claim 8, wherein said second coil is made by a B-class polyester enameled copper wire (PEW) with a 0.05-0.06 millimeter diameter.
